(19) United States
(12) Patent Application Publication
(10) Pub. No.: US 2021/0384608 A1
(43) Pub. Date: Dec. 9, 2021

(54) POLE TOP ADAPTER FOR WIRELESS ANTENNA

(71) Applicant: COmptek Technologies, LLC, Boulder, CO (US)

(72) Inventors: James D. Lockwood, Boulder, CO (US); Panos D. Kiousis, Boulder, CO (US)

(21) Appl. No.: 17/338,996

(22) Filed: Jun. 4, 2021

Related U.S. Application Data
(60) Provisional application No. 63/034,469, filed on Jun. 4, 2020.

(51) Int. Cl. H01Q 1/12; H01Q 1/22; H04B 3/54

(52) U.S. Cl. CPC H01Q 1/1242; H01Q 1/22; H04B 2203/5441; H01Q 1/1207; H04B 3/542

(57) ABSTRACT

An antenna support connector for connecting an antenna assembly to a utility pole. The connector includes a plate having an upper surface and a lower surface where the lower surface is configured for engagement against an upper end surface of a pole. The plate includes a plurality of elongated apertures that extend through the plate between its upper and lower surfaces. Attachment element extends through each of the elongated apertures, which permit the attachment elements to be positioned against a sidewall (e.g., interior or exterior) of the pole. The attachment elements are adjustable to permit compressing the connector against the top surface of the pole.

### CROSS REFERENCE

The present application claims the benefit of the filing date of U.S. Provisional Application No. 63/034,469 having a filing date of Jun. 4, 2020, the entire contents of which is incorporated herein by reference.

### FIELD

The present disclosure is broadly directed to wireless access points (e.g., wireless radios/antennas) that provide coverage for local service areas. More specifically, the present disclosure is directed to a support assembly that allows securing a wireless access point (e.g., wireless antenna assembly) to an existing utility pole.

### BACKGROUND

In wireless communication networks, high-powered base stations (e.g., towers supporting antennas) commonly provide service over large geographic areas. Each base station is capable of serving wireless user devices in a coverage area that is primarily determined by the power of the signals that supported antennas can transmit. Frequently, high-powered base stations (e.g., macro stations) are located in a grid pattern with each base station mounting various antennas elevated on a tower. While such towers have previously provided adequate coverage for many wireless applications, such high-powered base stations tend to be too widely spaced for newer high-bandwidth wireless applications.

To improve wireless access, providers are moving toward smaller stations that provide enhanced coverage for more limited geographic areas. That is, to augment the coverage of the wireless network, wireless transceiver devices/antennas (e.g., access points) with relatively small coverage areas (and serving capacities) are deployed. Depending on their coverage area and serving capacities, these wireless transceiver devices are referred to as “femto” cells or “pica” cells. For simplicity and generality, the terms “local access point” or “access point” are used herein to refer to a wireless transceiver access point that is configured to serve wireless user devices over relatively small coverage areas as compared to a high-powered base station that is configured to serve a relatively large coverage area (“macro cell”).

The increasing use of RF bandwidth or ‘mobile data’ has required a corresponding increase in the number of access points to handle the increased data. By way of example, 5G wireless networks promise greatly improved network speeds and are currently being planned and implemented. Such networks typically require shorter RF transmission distances compared to existing networks and thereby require a denser network of access points. Along these lines, access points are, in some instances, being installed in urban areas to serve several city blocks or even to serve a single city block. Such installations are often below roof-top level of surrounding buildings. That is, local access points are being installed at ‘street-level’ sites typically on small dedicated cell poles. The increasing number of local access points is sometimes referred to as densification of wireless infrastructure. Residents often object to such densification in their neighborhoods due to the aesthetic concerns of numerous small cell poles. Accordingly, it would be desirable to increase the number of local access points without increasing cell pole density.

### SUMMARY

Various aspects of the present disclosure are based on the realization that significant infrastructure exists that could be upgraded for use supporting local access points. For instance, various utility poles currently exist within public rights-of-way (as well as other locations) that could be upgraded for additional uses. By way of example, an urban city block of approximately 330 feet by 330 feet may contain approximately sixteen streetlights and may have traffic lights one or more corners. Such utility poles are typically included within the public right-of-way and are typically connected to the electricity grid. These existing utility poles provide existing locations that may be utilized to support local access points without increasing the density of utility poles in the local environment.

The present disclosure is broadly directed to a wireless access point mounting connector or support assembly that allows a wireless access point (e.g., a set of radios and/or antennas) to be securely attached to an existing utility pole at an elevated location. Utilization of existing utility poles to support such wireless access points may improve wireless coverage and/or capacity of a service area without increasing the number of support structures (e.g., cell poles) within that service area. In various embodiments, an antenna support structure is provided that may connect to a variety of differently configured utility poles. Once connected to a utility pole (e.g., existing utility pole), the support structure may provide a secure platform for mounting a wireless access point (e.g., antenna housing) to the utility pole.

In one aspect, an antenna support assembly or connector for attachment to a pole is provided. The connector includes a plate having an upper surface and a lower surface where the lower surface is configured for engagement against an upper end surface of a pole. The plate includes a plurality of elongated apertures that extend through the plate between its upper and lower surfaces. The elongated apertures extend radially outward from an interior (e.g., common location) of the plate. An attachment element extends through each of the elongated apertures. The attachment elements are configured to fixedly attach the plate to the pole. Typically, each attachment element includes a lower end configured to connect to a sidewall of the pole below the upper end surface of the pole and below the bottom surface of the plate and an upper end extending through the elongated aperture of the plate. The lower end and/or the upper end includes an adjustable fastener for securing the attachment element to the plate or the pole.

The elongated apertures permit selective positioning of the attachment elements. That is, the elongated apertures allow the plate to connect to differently configured poles. More specifically, the elongated apertures permit the plate to connect to poles having differing cross-dimensions (e.g., diameters). The elongated apertures may have equal or unequal angular spacing around the plate. The plate, may further include one or more additional apertures (e.g., interior apertures). The interior apertures may be disposed above a hollow interior of the pole when the plate is attached to the pole. Such interior apertures may permit cabling or wiring to pass through the interior of the pole to an antenna housing supported by the connector. Additional apertures may be provided to secure an antenna housing to the connector. In an embodiment, the antenna housing is part of the connector.

In an arrangement, the connector includes a second plate spaced above and fixedly connected to the top surface of the plate. In such an arrangement, the connector may include a perforated sidewall extending between peripheries of the two plates. In such an arrangement, the connector may form an inlet plenum for a supported antenna housing.

In another aspect, a method is provided for attaching an antenna housing to the top of an existing utility pole. The method includes exposing an upper end surface of a utility pole. The upper end surface may be defined by a top edge of a sidewall of a generally hollow utility pole. An attachment plate may be disposed on the upper end surface of the utility pole, where the attachment plate has a plurality of elongated apertures extending radially outward from a central location on the plate. Attachment elements, extending through the elongated apertures, may be positioned outward along the elongated apertures until a lower end portion of each attachment element engages a sidewall of the pole. The lower portion of the attachment element may be affixed to the pole. The upper end of the attachment element may then be adjusted to compress the plate against the top surface of the pole. Once the plate is securely fastened to the pole, and antenna housing or antenna support structure may be affixed to the attachment plate.

### BRIEF DESCRIPTION OF THE DRAWINGS

FIG. 1A illustrates a utility pole.

FIG. 1B illustrates a utility pole reconfigured to support an antenna housing.

FIG. 2A illustrates perspective view an antenna housing mounted on a utility pole.

FIG. 2B illustrates an exploded view of FIG. 2A.

FIG. 2C illustrates a side view of an embodiment of a connector attached to a utility pole.

FIG. 3A illustrates a connector disposed above the top surface of a utility pole.

FIG. 3B illustrates the connector of FIG. 3A attached to the utility pole.

FIGS. 4A and 4B illustrate cross-sectional views of FIGS. 3A and 3B, respectively.

FIGS. 5A-5D illustrate different configurations of an abutment plate.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

The present disclosure is broadly directed to a wireless access point mounting connector that allows a wireless access point (e.g., a set of antennas) to be securely attached to an existing utility pole at an elevated location. Utilization of existing utility poles to support such wireless access point may improve wireless coverage and/or capacity of a service area without increasing the number of support structures (e.g., cell poles) within that service area. In various embodiments, an antenna support structure is provided that may connect to a variety of differently configured utility poles. Once connected to a utility pole (e.g., existing utility pole), the support structure may provide a secure platform for mounting a wireless access point (e.g., antenna housing) to the utility pole.

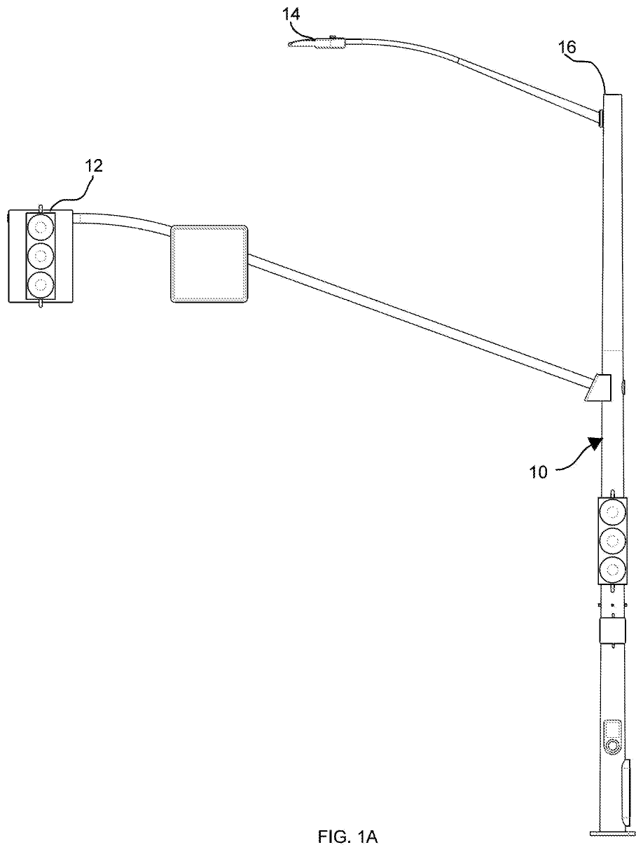

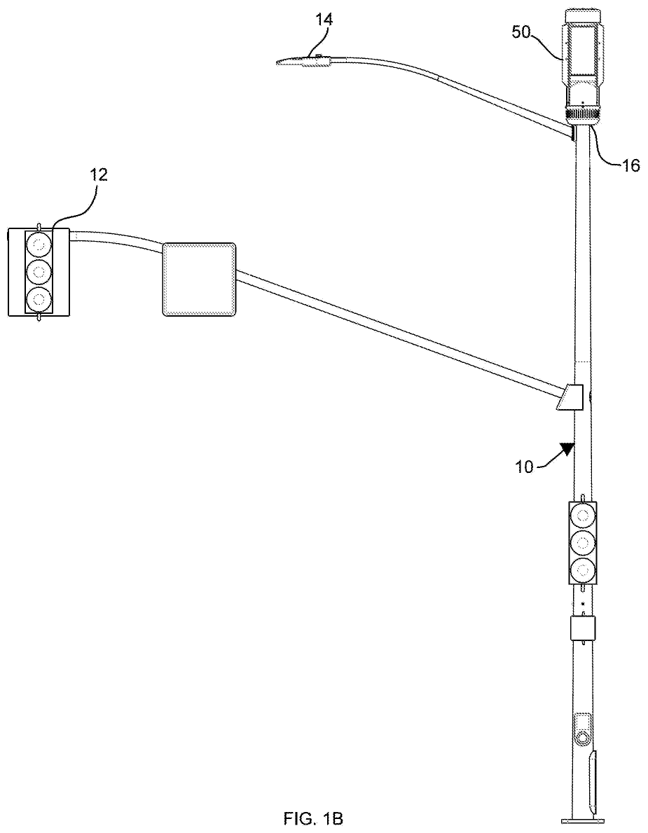

FIGS. 1A illustrates a utility pole 10 configured to supporting a traffic light 12 and a streetlight 14. The pole 10 has a free upper end 16 that could be utilized to support a wireless access point. By way of example, FIG. 1B illustrates this existing utility pole 10 supporting a wireless access point or radio/antenna housing 50 (hereafter “antenna housing”). In the utility pole industry, it is common for a pole manufacturer to provide a single pole that may be modified for different applications. For instance, the utility pole 10 of FIG. 1A, which supports the traffic light and streetlight, may have an upper section removed resulting in a shorter pole that only supports a traffic light. In contrast the pole of FIG. 1A may omit the traffic light and support only a streetlight. Such a utility pole may be cut to a desired length based on its application. Further, many such poles that can be cut to a desired length taper from a wider base end to a narrower upper end. That is, a cross-dimension (e.g., diameter of a round pole) transverse to the long axis of the pole may decrease along its length (i.e., height when installed). When such a tapering pole is cut to a desired length, the cross-dimension of the upper or free end of the pole varies based on the location where the pole is cut. Accordingly, a connector for attachment to the upper end of a variable height pole for supporting a wireless access point would typically require a connector having customized size. Furthermore, different poles from different manufactures may have varying configurations. Some may be tapered while others may have a constant cylindrical dimension or other cross-sectional dimension (e.g., hexagonal, octagonal etc.). Accordingly, it would be desirable to provide a connector that may be securely fitted to a plurality of differently configured utility poles.

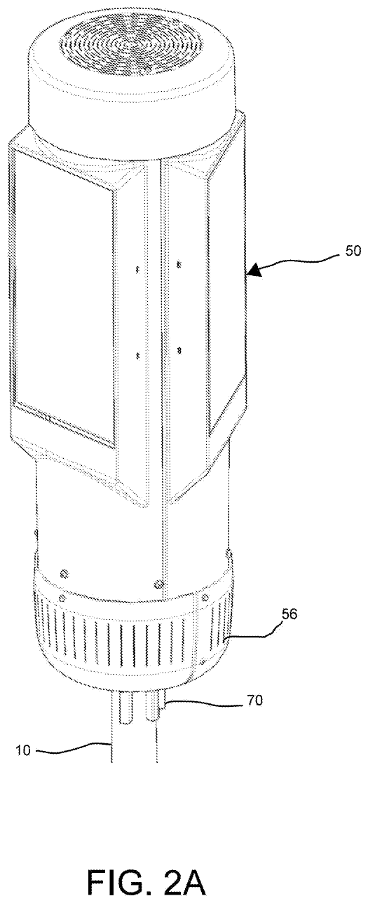

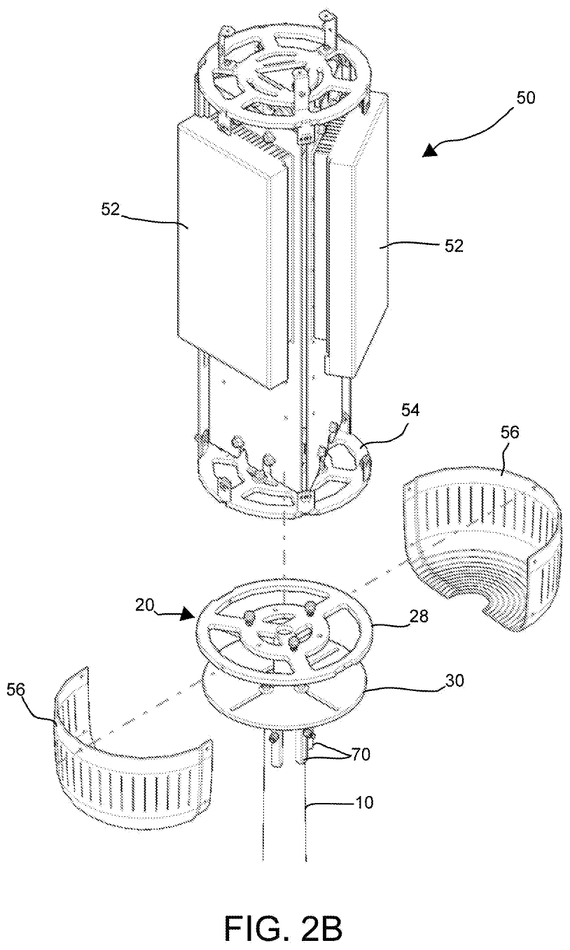

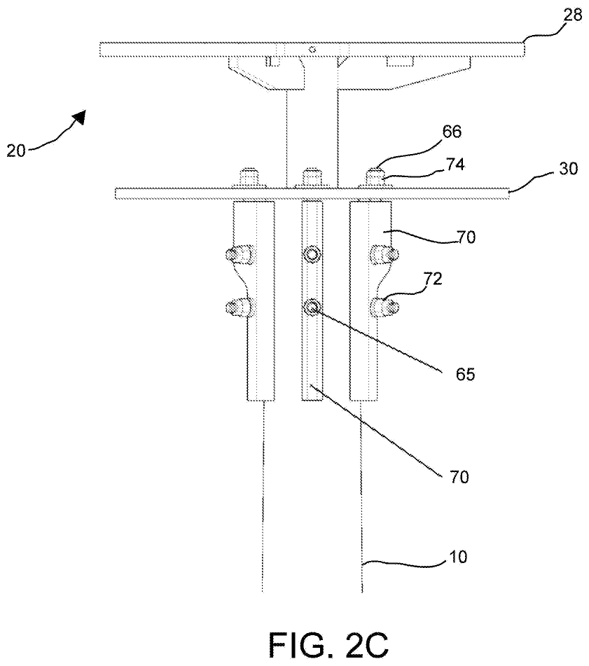

FIGS. 2A and 2B illustrate a perspective view and an exploded perspective view of the antenna housing 50 supported on the free end of the utility pole 10 via a connector 20 in accordance with the present disclosure, respectively. FIG. 2C illustrates a side view of the connector 20. FIG. 2A illustrates a fully assembled antenna housing 50 while FIG. 2B illustrates the antenna housing with various shrouds removed to better illustrate the radios/antennas 52 supported within the interior of the housing. A similar antenna housing is described in co-owned U.S. patent application Ser. No. 16/837,234 filed on Apr. 1, 2020, the entire contents of which are incorporated herein by reference. As shown, an adjustable pole connector device 20 (hereafter ‘connector’) is utilized to engage the upper end of the pole 10 to provide a secure mount for attaching the antenna housing 50 to the pole 10. In the illustrated embodiment, the connector 20 has an antenna support plate 28 (e.g., upper plate) and a spaced abutment plate 30 (i.e., lower plate). In this embodiment, the support plate 28 is configured for attachment, to the antenna housing 50 while the abutment plate it configured for positioning and connection to the upper end of the pole 10.

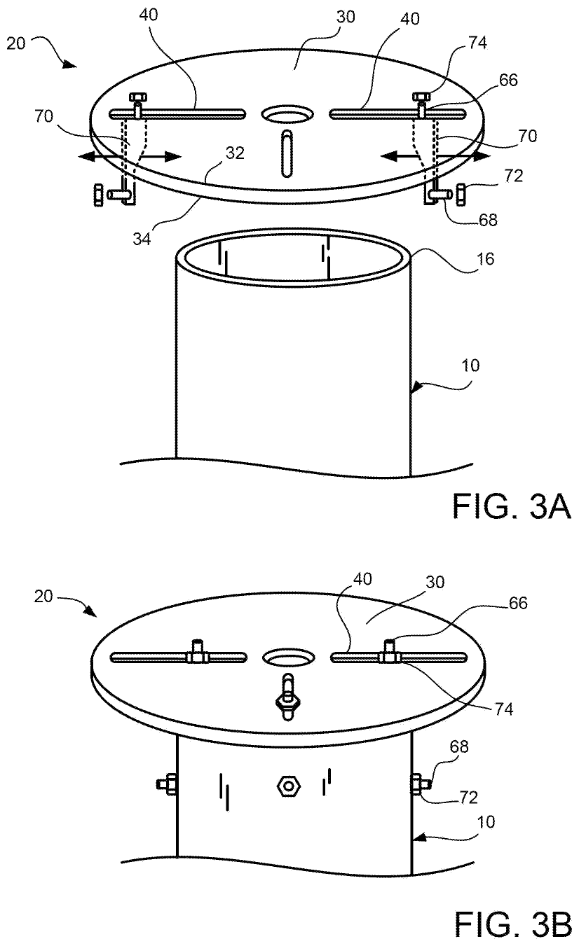

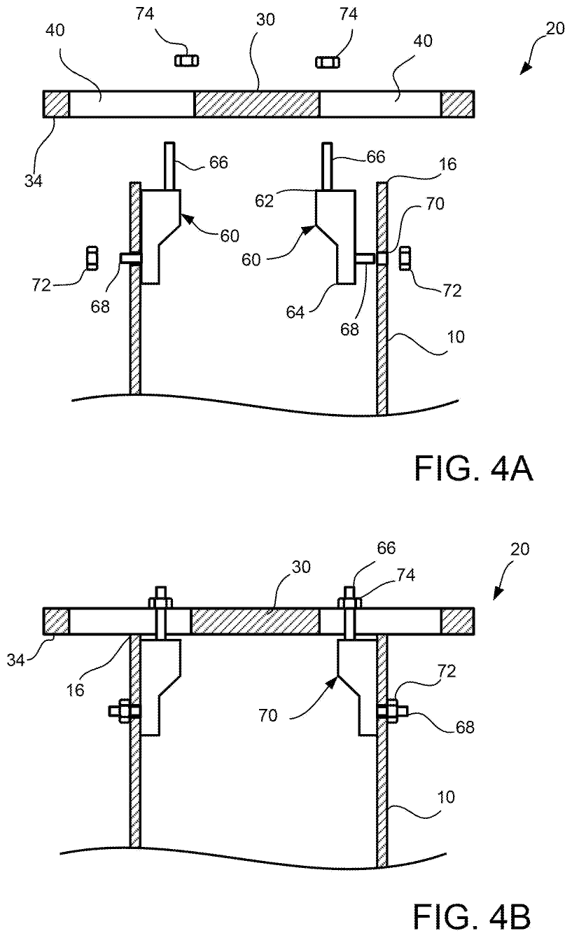

FIGS. 3A-4B variously illustrate one embodiment of the abutment plate 30 of the connector 20 of FIG. 2B. Though discussed above as having both an antenna support plate 28 for connection to the antenna housing and the abutment plate 30 for connection to the utility pole, it will be appreciated that the connector 20 may include a single plate (e.g. abutment plate 30) that both connects to the utility pole and provides a mounting surface for connection to the antenna housing. Accordingly, the embodiment of the connector 20 as illustrated in FIGS. 3A-4B having a single plate is considered novel by itself. As shown in FIGS. 3A and 3B the abutment plate 30 has an upper surface 32 and bottom surface 34. The bottom surface 34 is typically a planar surface that is configured for abutment/disposition (e.g., compression) against an upper edge surface of the upper end 16 of a utility pole 10. As illustrated in FIGS. 3A-4B, the upper end of the pole is disposed in a common plane. Accordingly, when the generally planar bottom surface 32 of the plate 30 abuts against this surface, the pole may provide a stable support surface for the connector 20 and any elements disposed thereon.

In order to attach the connector plate 30 to a plurality of utility poles having differing dimensions (e.g., diameters) and/or shapes (e.g., round, hexagonal, etc.), the plate utilizes a plurality of elongated apertures 40 that allow the outward and inward adjustment of a corresponding plurality of attachment elements 60. The elongated apertures 40 extend through the plate 30 between its upper surface 32 and its bottom surface 34. Most commonly, these elongated apertures extend radially outward from a common point on the plate 20. By way of example, when the plate is circular as illustrated, the elongated apertures may radially extend from the center (e.g., focus) of the circular plate. However, it will be appreciated that the plate need not be circular. The elongated apertures allow the attachment elements to be positioned against a sidewall (e.g., interior, or exterior) of the pole when the plate is disposed on the top of the pole.

The attachment elements 60 have a first or upper end 62 that is configured to extend through one of the elongated apertures 40 and a lower end 64 that, is configured for connection to a sidewall of a pole 10. In one non-limiting embodiment illustrated in the cross-sectional views of FIGS. 3A and 3B, the attachment elements 60 may have a first upper threaded stud 66 (e.g., bolt) connected to its upper end 62 and a lower threaded stud 68 connected to its lower end 64. In this embodiment, the studs 66, 68 may be transverse. In other embodiments, the lower end of the attachment elements may include an aperture to receive a bolt or stud 65. See, e.g., FIG. 2C. In the embodiment of FIGS. 3A-4B, the attachment elements 60 are disposed within a hollow interior of the pole. However, this is not requirement and it will be appreciated that the attachment elements may be disposed on the exterior surface of a pole. As will be appreciated, the ability to position the attachment elements 60 within an interior of the pole or on the exterior of the pole allows the connector 20 to be utilized with poles having vastly different cross-dimensions. In the illustrated embodiment, apertures 70 may be formed (e.g., drilled) through the pole 10 at angular locations aligned with the elongated apertures in the plate 30. These apertures 70 may be disposed a predetermined distance below the upper edge 16 of the pole 10. This predetermined distance may be selected based on a known length of the attachment element 60.

The lower threaded stud 64 may be disposed through the aperture 70 in the sidewall of the pole 10 secured in place using, for example, a threaded nut 72. Once all attachment elements 60 are connected to the sidewall of the pole 10, the plate 30 may be positioned over the top of the pole 10 such that the upper threaded studs 66 extend through their respective elongated aperture 40. It will be appreciated that the elongation of the apertures 40 permits attaching the plate 30 to the top surface of poles having differing cross-dimensions. Once the plate 30 is positioned, threaded nuts 74 may be threaded onto the upper threaded studs 66. More specifically, the upper threaded nuts 74 may be tightened to provide a tensile force between the upper and lower ends of the attachment element 60. This compresses the bottom surface of the plate 30 against the upper edge 16 of the pole 10 securely fastening the plate 30 to the pole 10. The plate 10 may then be utilized to secure an antenna housing 100 to the pole 10.

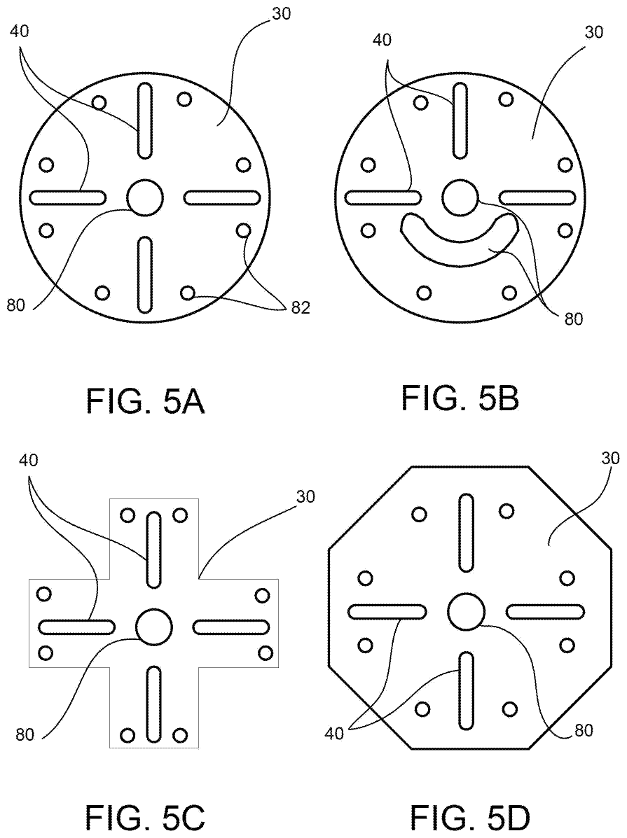

FIGS. 5A-5D illustrate various embodiments of abutment plates 30 that may be utilized. As shown, the number and orientation of the elongated apertures (e.g., slots) may be varied. For instance, the elongated apertures may have equal angular spacing around the plate. See FIGS. 5A, 5C and 5D. Alternatively, the elongated apertures may be unequally spaced around the plate. See FIG. 5B. Such unequal spacing may be desired when an interior portion of the pole is unavailable for an attachment element. By way of example, the pole of FIG. 1B may have a light mast disposed near its upper end preventing use of an interior portion of the pole with an attachment element. Of further note, the plate may have configurations other than circular. See, e.g., FIGS. 5C and 5D. What is important is that the plate be large enough to extend across an open end of a hollow pole.

Preferably, any plate configuration will have one or more interior apertures 80 disposed proximate to the center of the plate (not necessarily aligned with the center). Such an interior aperture(s) permits wiring from a supported antenna housing to extend through the plate 30 and through the hollow interior of an underlying utility pole. In addition, each plate 30 may have one or more optional attachment apertures 82 located, for example, proximate to its outer periphery for use in attaching an antenna housing to the plate 30. The size, shape, number, and location of such apertures 82 may be varied.

As noted in relation to FIGS. 2B and 2C, the connector 20 may include the lower abutment plate 30 as well as an upper support plate 28. The lower abutment plate 30 may include any of the features described above. In the illustrated embodiment, the lower plate includes three elongated slots or apertures 40 and one or more interior apertures to permit cabling (not shown) to pass through the abutment plate 30 form the interior of the pole 10. The support plate 28 is spaced above an upper surface of the abutment plate 30 and, in the illustrated embodiment, the plates 28, 30 are connected by a single central strut 22. However, it will be appreciated that the plates may be connected by multiple struts. connected by various struts (not shown). In this embodiment, the central strut 22 is a hollow or tubular member that connects about apertures in the plates 28, 30. Such a hollow strut provides a passage through the two spaced plates 28, 30 of the connector 20.

As best illustrated in FIG. 2B, the support plate 28 may be configured to include a plurality of apertures to permit air to flow into a supported antenna housing 50. In the illustrated embodiment, the support plate is generally configured as a spoke and hub annular plate having large opening between the spokes, a central hub, and an outer rim. These opening may correspond to a bottom plate 54 of the antenna housing. In this regard, air may readily pass into the antenna housing to provide cooling for antenna or radios disposed therein. The use of the spaced plates provides an important benefit. Specifically, the spacing between the outer peripheries of the support plate 28 and the abutment plate 30 results in an opening through which air may enter a supported antenna housing 50. As shown in FIGS. 2A and 2B a perforated sidewall 56 may extend between the outer peripheral edges of the two plates 28, 30. The perforation permit air to enter the space between the plates 28, 30 and then enter into the antenna housing via, for example, natural or forced convection. As illustrated, the perforated sidewall 56 is a multipiece shroud that encloses the interior of the connector 20. Generally, the spaced plates and the perforated sidewall define an inlet plenum for a supported antenna housing.

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. An antenna support device for attachment to a pole, comprising:
a plate having an upper surface and a lower surface, the lower surface being generally planar for engagement with an upper end of a pole;
a plurality of elongated apertures extending through the plate between the upper surface and the lower surface, each of the elongated apertures extending outward from an interior of the plate toward a peripheral edge of the plate; and
a plurality of attachment elements, wherein one attachment element extends through a respective one of the elongated apertures, each attachment element having:
an upper end extending through the elongated aperture; and
a lower end configured to connect to a sidewall of said pole below the lower surface of the plate, wherein at least the lower end or the upper end includes an adjustable fastener for securing the attachment element to the plate or said pole.

2. The device of claim 1, wherein the upper end of each of the attachment elements is configured to be selectively moved along a length of the elongated aperture.

3. The device of claim 1, wherein the plurality of elongated apertures, have an equal angular spacing around a common location on the plate.

4. The device of claim 1, wherein there are at least three elongated apertures.

5. The device of claim 1, wherein the plurality of elongated apertures have an unequal spacing around the common location on the plate.

6. The device of claim 1, wherein the plate is substantially circular, wherein the common point is a center of the plate.

7. The device of claim 1, wherein the plate further comprises at least one aperture located within an interior of plate.

8. The device of claim 1 or any other claim, wherein the adjustable fastener is configured to apply a tensile force between the upper end and the lower end of the attachment element.

9. The device of claim 1, wherein the upper end of the attachment element comprises a male or female threaded section.

10. The device of claim 9, wherein the lower end of the attachment element comprises a male or female threaded section.

12. The device of claim 1, wherein the plate is a first plate, further comprising:
a second plate spaced from and fixedly connected the first plate.

13. The device of claim 12, wherein the first plate and the second plate are connected by at least a first strut extending between the first plate and the second plate.

14. The device of claim 13, wherein the first strut is a hollow tubular strut.

15. The device of claim 12, wherein the tubular strut is centrally located within peripheries of the first plate and the second plate.

16. The device of claim 15, further comprising a perforated sidewall extending between a periphery of the first plate and a periphery of the second plate.

17. The device claim 15, further comprising:
an antenna housing connected to the second plate, the antenna housing supporting at least one wireless antenna or wireless radio.

18. A method for attaching an antenna housing to the top of a utility pole, comprising:
exposing an upper end surface of a utility pole, wherein a top edge of a sidewall of the utility pole defines a hollow interior of the pole;
disposing an attachment plate on the upper end surface of the utility pole, the attachment plate having a plurality of elongated apertures extending radially outward from a central location on the plate;
sliding attachment elements, extending through the elongated apertures, radially outward along the elongated apertures until a lower end portion of each attachment element engages a sidewall of the pole;
affixing the lower end portion to the pole and affixing an upper end portion of each attachment element relative to the attachment plate; and
mounting an antenna housing to the attachment plate.
